(19) United States
(12) Patent Application Publication
(10) Pub. No.: US 2016/0253922 A1
(43) Pub. Date: Sep. 1, 2016

(54) Systems and Methods of Food Management

(71) Applicant: Food Friend, Inc., San Francisco, CA (US)

(72) Inventors: Alexander Michael Kremen, San Francisco, CA (US); Michelle Esteban, San Francisco, CA (US)

(21) Appl. No.: 14/732,735

(22) Filed: Jun. 7, 2015

Related U.S. Application Data
(60) Provisional application No. 62/176,792, filed on Feb. 27, 2015.

(51) Int. Cl. G09B 19/00; G09B 5/02

(52) U.S. Cl. CPC G09B 19/0092; G09B 5/02

(57) ABSTRACT

Methods, systems, and apparatuses for food management are described. In some embodiments, a request for a meal plan is received, where the request specifies criteria associated with a first account of a first user. A set of meal plans is presented in response to the request, where each meal plan in the set of meals plans is associated with a particular user and fulfills at least a portion of the criteria. A user selection identifying a first meal plan from the set of meal plans is received. The first meal plan is associated with a second account of a second user and specifies one or more recipes. The first meal plan is provided to the first account in response to the user selection.

### PRIORITY

This application claims a priority benefit of U.S. Provisional Application Ser. No. 62/176,792, entitled, “Systems and Methods of Food Management,” filed Feb. 27, 2015, the disclosure of which is incorporated by reference herein in its entirety.

### BACKGROUND

Meal planning is often a tedious task, especially in households with several people. In some cases, the act of planning meals (e.g., researching recipes, grocery shopping, etc.) can take hours.

### BRIEF DESCRIPTION OF DRAWINGS

The present disclosure is illustrated by way of example and not limitation in the figures of the accompanying drawings, in which like references indicate similar elements and in which:

FIG. 1 is a block diagram depicting an architectural overview of a system for food management, in accordance with an example embodiment;

FIG. 2 is a block diagram depicting an example computing device for food management, in accordance with an example embodiment;

FIG. 3 is a flow chart showing an example method for food management, in accordance with an example embodiment; and

FIG. 4 is a block diagram of a machine in the example form of a computer system within which a set of instructions, for causing the machine to perform any one or more of the methodologies discussed herein, may be executed, according to some embodiments.

### DETAILED DESCRIPTION

The description that follows includes illustrative systems, methods, apparatuses, and techniques that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known structures and techniques have not been shown in detail.

Some embodiments described herein provide techniques for food management. A user may manage one or more recipes via a computing device, and the user's recipes may be used to create a meal plan for the user. A meal plan may specify one or more recipes. In some embodiments, a meal plan may specify one or more recipes to be prepared for each meal during a particular duration of time. For example, the user may create a meal plan for a given week, where the meal plan specifies which recipes the user would like to prepare for each meal of that week. The term “meal” may refer to one or more dishes and/or drinks to be prepared for a particular time period (e.g., breakfast, lunch, afternoon snack, dinner, etc.). In some embodiments, a meal may refer to one or more dishes that are already prepared and ready to eat (e.g., a frozen dinner). The term “recipe” may refer to a set of instructions that specifies how to prepare a particular dish and/or drink as well as the ingredients, and the amount of each ingredient, to be used in preparing the dish. The term “ingredient” may refer to any element or component of a dish and/or drink (e.g., milk, eggs, sugar, a box of macaroni and cheese, etc.).

A meal plan may be used to identify ingredients associated with recipes in the meal plan. The identified ingredients may be used to create a grocery list of items to be purchased. In some embodiments, the ingredients may be identified based on an inventory of ingredients the user may already possess. In some embodiments, the identified ingredients may be purchased using the user's computing device, and the order may be fulfilled by one or more providers (e.g., a particular grocery store, a transportation service, etc.) and/or fulfilled by the food management system.

The techniques described above may be facilitated by a food management system. The food management system may be associated with one or more servers that may communicate with computing devices of users of the food management system and computing devices of providers associated with the food management system. In some embodiments, users and providers may register for accounts associated with the food management system, allowing users and providers to access the services provided by the food management system. The services associated with the food management system may be accessed by computing devices of users and providers in any suitable manner, such as via a website, an application, and the like.

In some embodiments, users may select and/or create a particular meal plan, and the ingredients associated with the meal plan may be automatically ordered and/or delivered. For example, a user may select and/or create a meal plan and click on an order button, where clicking on the button may result in the food management system automatically determining the ingredients to be purchased (e.g., based on the meal plan and/or based on the user's inventory of ingredients) and ordering and/or delivering the ingredients for the user.

In some embodiments, users may create meal plans that may be shared with other users. For example, users may create a meal plan that is specific to certain criteria, constraints, and/or preferences, such as a type of cuisine (e.g., vegetarian, French, low-carbohydrate, etc.). The food management system may allow users to request, search for, and/or view meals plans created by other users such that the meals plans may be used by those users. In some embodiments, a user may allow other users to view, access, and/or use the meal plans created by that user at no cost or for a certain fee (e.g., a subscription fee associated with a particular amount of time, a fee for each meal plan, etc.). In some embodiments, users may tag their meal plans with one or more keywords specifying characteristics of a meal plan for meal plan searching purposes (e.g., type of cuisine, type of diet, ingredients included in and/or excluded from the meal plan, grocery stores selling ingredients for a particular meal plan, a particular genre, a calorie range, a difficulty rating, a price, a number of people and/or servings, etc.). For example, a user searching for meal plans that are vegan may be found based on meal plans that are tagged with the keyword “vegan.” In some embodiments, the food management system may provide various notifications to users regarding available meal plans created by other users. For example, if a user requests a meal plan with a particular set of characteristics, the food management system may notify the user of any meal plans fulfilling those characteristics when those meal plans become available.

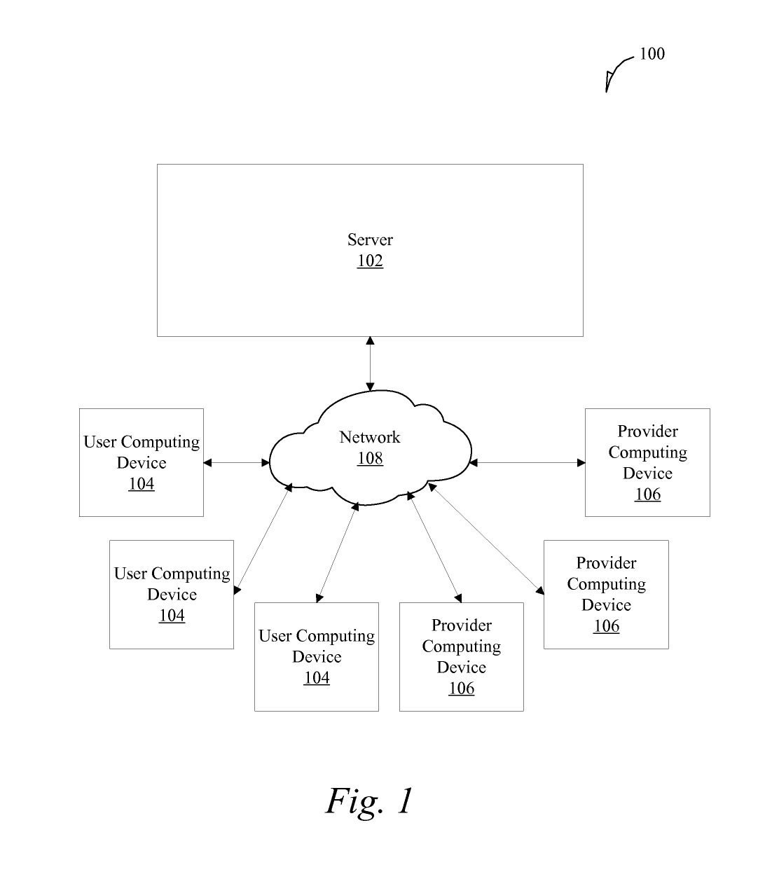

FIG. 1 is a block diagram depicting an architectural overview of a system 100 for food management. In some embodiments, the system 100 comprises a server 102, user computing devices 104, and provider computing devices 106. The components of the system 100 may be connected directly or over a network 108, which may be any suitable network. In various embodiments, one or more portions of the network 108 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The system 100 may include any number of user computing devices 104. In some embodiments, a user computing device may be associated with a user of a food management service provided by the server 102 (e.g., a user using the food management service to create meal plans, plan meals, order ingredients, etc.). A user may be an individual and/or any suitable entity (e.g., a business). The user computing device 104 may be any suitable computing device, such as a smart phone, a personal digital assistant (PDA), a mobile phone, a personal computer (PC), a laptop, a virtual reality device, a computing tablet, a wearable device, or any other device suitable for accessing features associated with the server 102. The user computing device 104 may access the server 102 or the provider computing devices 106 directly, via network 108, or via a third-party system. For example, the user computing device 104 may access the provider computing devices 106 via the server 102.

The system 100 may include any number of provider computing devices 106. A provider computing device 106 may be a computing device associated with any suitable provider of a product and/or a service, such as food suppliers (e.g., grocery stores, restaurants with leftover supplies, specialty food stores, etc.), transportation service providers (e.g., ride-sharing service providers, delivery service providers, etc.), and the like. The provider computing device 106 may also be any suitable computing device, such as a server computing device, a smart phone, a PDA, a mobile phone, a personal computer, a laptop, a computing tablet, or any other device suitable for providing products and/or services. The provider computing device 106 may access the server 102 or the user computing devices 104 directly, via network 108, or via a third-party system. For example, the provider computing device 106 may access the user computing devices 104 via the server 102.

The server 102 may include a network-addressable computing system that may provide food management services, as described above. For example, server 102 may manage user and/or provider accounts, recipes, meal plans, calendars, grocery lists, ingredient purchases, recipe preparation, preferences, rankings, a data-driven view of the user, notifications to users, and the like. The server 102 may include any number of servers and may be any suitable server within any suitable environment (e.g., a cloud computing environment).

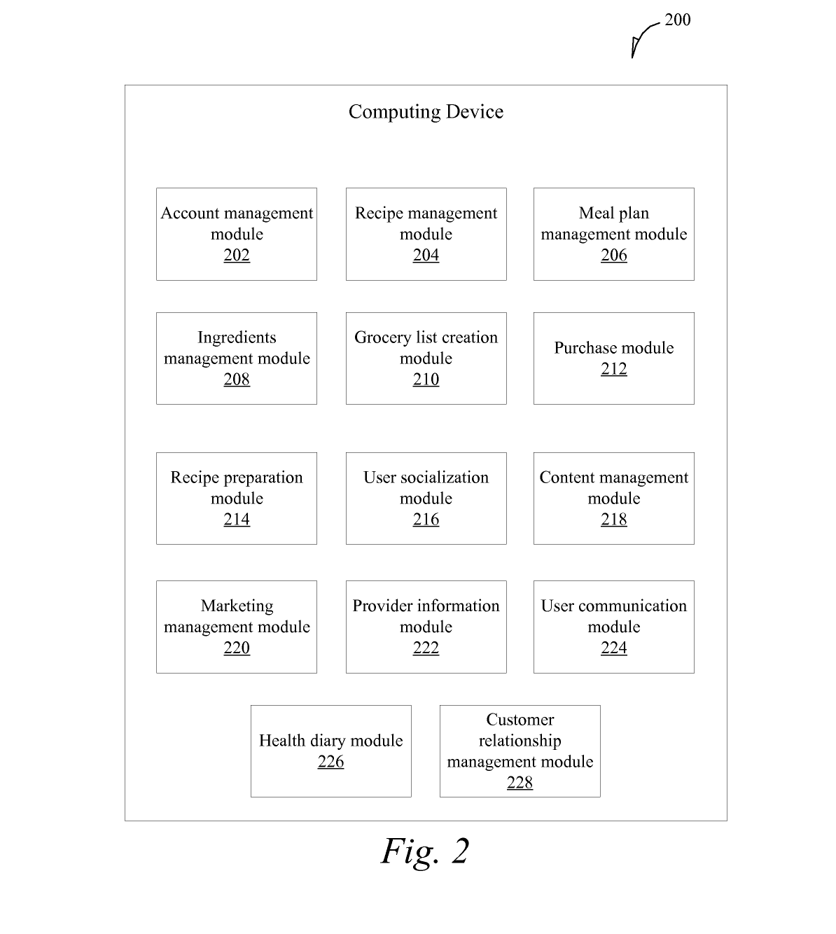

FIG. 2 is a block diagram depicting an example computing device 200 for food management. In some embodiments, the computing device 200 may be, or may be part of, the server 102 of FIG. 1. In some embodiments, one or more components shown in FIG. 2 may be part of an application running on the user computing device 104 of FIG. 1. The computing device 200 may include account management module 202, recipe management module 204, meal plan management module 206, ingredients management module 208, grocery list creation module 210, purchase module 212, recipe preparation module 214, user socialization module 216, content management module 218, marketing management module 220, provider information module 222, user communication module 224, health diary module 226, and customer relationship management module 228. The components of the computing device 200 may allow a user to manage their food by managing recipes, creating meal plans, purchasing ingredients, and the like.

The account management module 202 may be a hardware-implemented module that may manage and control accounts associated with users and/or providers. The account management module 202 may allow users and/or providers to create their respective account, create and manage profiles associated with the account (e.g., create and manage personalized pages associated with the user and/or provider), connect the account with other users and/or providers associated with the food management system and/or third-party social networking sites, synchronize the account with a third-party service (e.g., a website, application, etc.), specify whether the account is associated with a content provider (e.g., a user who provides content, such as recipes, videos, pictures, etc.), specify a user's preferences and/or favorite content, specify a user's settings (e.g., privacy settings), specify payment information (e.g., credit card account information), and the like.

The recipe management module 204 may be a hardware-implemented module that may manage and control recipes. The recipe management module 204 may maintain a database of recipes available to users. The database of recipes may include recipes from any source, such as the food management system itself, third-party websites, users, providers, and the like. In some embodiments, the database of recipes may include any user-generated recipes. In some embodiments, a user may use their computing device (e.g., an application on the computing device) to provide one or more recipes in any suitable manner, such as manually inputting the recipe, submitting an image of the recipe (e.g., added using optical character recognition (OCR)), importing a recipe shown on a third-party website, and the like. In some embodiments, the recipe management module 204 may automatically suggest ingredients as the user manually inputs a particular recipe. In some embodiments, the recipe management module 204 may provide recipe suggestions to users in any suitable manner. For example, a sponsor of a particular recipe may pay the food management system to suggest their recipe to users, or the food management system may use a computer-learning algorithm to predict recipes that a user may like based on past behavior (e.g., based on user-provided ratings of recipes, based on recipes that the user prepares at a particular frequency, etc.) and may suggest the predicted recipes to the user. In some embodiments, the recipe management module 204 may provide recipe suggestions based on user-specified preferences, ingredient prices, and/or availability of various ingredients. In some embodiments, the recipe management module 204 may automatically create a meal plan for a user based on a set of user-specified preferences and/or constraints. In some embodiments, the recipe management module 204 may suggest drink pairings (e.g., cocktail recipes) to pair with various recipes.

The recipe management module 204 may allow a user to search the recipe database for various recipes and/or meal plans, and the database may be searchable based on any suitable criteria. For example, the database may be searchable by tags associated with recipes, various categories associated recipes (e.g., brunch, football game appetizers, Thanksgiving dinner, French food, healthy food, unhealthy food, food associated with a particular diet, etc.), and the like. In some embodiments, the recipe management module 204 may allow users to subscribe to various meal plans, chefs, celebrities, teachers and/or educational companies, or any other entities that create and/or provide recipes and/or meal plans available to users. In some embodiments, the user may subscribe to such entities by paying a particular fee to the food management system and/or to the entity.

The recipe management module 204 may allow a user to associate one or more recipes with their account (e.g., add a recipe to a list of favorite recipes). In some embodiments, the recipe management module 204 may allow a user to customize recipes, ingredients, and meal plans that may have been provided to the user in any suitable manner (e.g., automatically, by suggestion, via a third-party website, etc.). In some embodiments, a user may customize ingredients in recipes manually and/or based on user-specified criteria relating to customization of ingredients, such as specifying that a particular ingredient in any recipe is to be replaced with another specified ingredient. For example, the user may provide user-specified criteria that indicates that any instance of broccoli in a recipe is to be replaced with Brussel sprouts, and any broccoli in recipes will automatically be replaced with Brussel sprouts based on the user-specified criteria. In some embodiments, a user may, manually and/or based on user-specified criteria, customize meal plans based on any suitable schedule (e.g., the user's schedule, schedules of people in the user's household, etc.).

The meal plan management module 206 may be a hardware-implemented module that may manage, control, and facilitate the creation of meal plans associated with a user account. The meal plan management module 206 may allow a user to create a meal plan for a particular duration of time by allowing the user to select various recipes to add for each meal of the meal plan. For example, a user may specify which recipes to prepare for each meal in the meal plan, where a meal may include one or more recipes. A user may also specify how many servings of each meal the user would like to prepare. For example, if a user plans to prepare a particular meal for a dinner party, the user may specify the number of people attending the dinner party such that the number of servings associated with each meal in the recipe may be determined and accounted for. In some embodiments, if a user account specifies that the user is associated with a particular diet (e.g., vegetarian, vegan, low-carbohydrate, low-calorie, etc.), the meal plan management module 206 may access data associated with the specified diet and may suggest meals plans that follow the specified diet, recipes that follow the specified diet, other users associated with the specified diet, and/or providers associated with the specified diet. For example, the meal plan management module 206 may access nutritional information associated with various recipes, identify recipes that are aligned with the user's particular diet, and recommend meal plans using the identified recipes in the user's meal plan. In some embodiments, the nutrition information for various recipes may be provided to the user. In some embodiments, the meal plan management module 206 may suggest meals plans based on past user behavior. In some embodiments, if a user creates a meal plan for a portion of a particular amount of time associated with the meal plan, the meal plan management module 206 may provide suggestions for recipes to complete the meal plan. In some embodiments, the meal plan management module 206 may communicate with other third-party services (e.g., third-party application) to receive and/or send data associated with meals plans, such as data associated with what to eat, how to create a meal plan, diet-specific meal ideas, whether a particular meal plan fits a particular diet restriction, and the like.

In some embodiments, the meal plan management module 206 may intelligently determine whether certain ingredients in the user's meal plan may be used to prepare other recipes in the user's meal plan. For example, if a meal plan uses half an onion for a particular recipe, the meal plan management module 206 may suggest other recipes to use in the meal plan that include the other half of the onion such that the ingredients may be maximized instead of wasted. In some embodiments, this may be performed based on the user's inventory of ingredients, ingredients the user may purchase, and the like. In some embodiments, the meal plan management module 206 may identify ingredients that the user already possesses in the user's inventory and may suggest various recipes to add to the user's meal plan based on that inventory and/or based on the user's preferences, past behaviors, ingredient prices at local grocery stores, and the like.

In some embodiments, the meal plan management module 206 may receive a request for a meal plan, where the request may specify criteria associated with a first account of a user. For example, a user may specify various criteria for a meal plan that the user wishes to request, such as specifying that the user wishes to request a vegetarian meal plan for two people. In response to the request, the meal plan management module 206 may send display data to display a set of meal plans, where each meal plan in the set of meal plans is associated with a particular user and may fulfill at least a portion of the criteria. For example, each meal plan displayed may be a meal plan associated with a particular user who created the meal plan, and each meal plan displayed may be a meal plan that fulfills at least some of the criteria specified by the request. In some embodiments, the meal plans may be displayed in a particular order, such as in an order that is based on a degree to which the specified criteria are fulfilled. The meal plan management module 206 may receive a user selection identifying a first meal plan from the set of meal plans, where the first meal plan is associated with a second account of a second user and specifies one or more recipes. For example, the user may provide a user selection identifying the meal plan that the user chooses from the set of meal plans displayed. The meal plan management module 206 may then associate the first meal plan with the first account of the user in response to the user selection such that the user may access and use the first meal plan. In some embodiments, the meal plan may be transferred from the account of the second user (e.g., the user who created the meal plan) to the account of the first user (e.g., the user who requested the meal plan). In some embodiments, the meal plan may be a specific set of recipes, where the specific set of recipes are transferred from the account of the second user to the account of the first user. In some embodiments, the meal plan may be associated with recipes relating to the meal plan, where each recipe associated with the meal plan may be transferred from the account of the second user to the account of the first user over a period of time. For example, a set of recipes associated with the meal plan may be transferred daily.

The ingredients management module 208 may be a hardware-implemented module that may manage and control the determination of ingredients for various recipes. For example, the ingredients management module 208 may identify ingredients associated with a user's meal plan, including identifying amounts of ingredients to be used in recipes specified by the user's meal plan.

The grocery list creation module 210 may be a hardware-implemented module that may manage, control, and facilitate the creation of a list of items that the user is to purchase in order to prepare the recipes in the user's meal plan. The list of items may be based on the ingredients identified by the ingredients management module 208, or may be based on the identified ingredients less the ingredients that the user already has in the user's inventory of ingredients. The grocery list creation module 210 may convert ingredients identified by the ingredients management module 208 into a grocery list of items. For example, if the ingredients management module 208 identified that a total of 3 cups of milk are to be purchased for meals during a week, the grocery list creation module 210 may determine that a quart of milk is to be purchased, which would be the smallest amount of milk that may be purchased in order to make the recipes in the meal plan. In some embodiments, a user may specify preferences relating to sizes of items to purchase.

In some embodiments, the grocery list creation module 210 may maintain a list of ingredients that the user has in their inventory, and that inventory list may be updated by the user. In some embodiments, the grocery list creation module 210 may display a list of the identified items and allow the user to remove certain items from the list if the user already has those ingredients in their inventory. In some embodiments, the grocery list creation module 210 may allow a user to add additional items to the grocery list that the user may wish to purchase (e.g., toilet paper, trash bags, etc.) In some embodiments, the grocery list creation module 210 may sort the list of items in an order that is based on where the items may be found in a store (e.g., based on grocery store aisles). In some embodiments, the grocery list creation module 210 may sort the list of items in an order based on when each particular item is to be used in the meal plan. For example, a meal plan that is created for a particular week (e.g., Sunday through Saturday) may include a Thursday dinner involving salmon, and the grocery list creation module 210 may sort the list of items for the meal plan based on the time the items are to be used (e.g., by moving salmon toward the middle or bottom of the list), which may indicate to the user that the items toward the end of the list may be purchased later in the week such that the ingredients used may be fresher. The user may use the created list to shop for the items in a physical grocery store. In some embodiments, the list of items may be used by a user to shop for the items in a grocery store.

In some embodiments, the grocery list creation module 210 may allow a user to provide feedback about availability of various items in a grocery store. For example, if a user is shopping in a store, the user may provide feedback about items that are on sale, items that are out of stock, items that are available, and the like.

The purchase module 212 may be a hardware-implemented module that may manage, control, and facilitate the online purchase of the ingredients in the list. The purchase may be made through the computing device 200 and/or may be made by being redirected to a particular website for ordering ingredients from a provider. In some embodiments, the purchase module 212 may allow a user to purchase the ingredients at a particular provider (e.g., based on user selection, based on user preferences, based on loyalty memberships the user has with a particular online store, etc.). The purchase module 212 may send the user's request for the ingredients to the specified provider (e.g., provider computing device 106), and the provider may fulfill and/or deliver the order. The user may have the option to pick up the fulfilled order in a physical store of the provider (e.g., by entering the store and picking up the ingredients, by picking up the ingredients via a drive-through window, etc.) or have the fulfilled order delivered to the user. In some embodiments, the order may be delivered to the user by the provider of the ingredients or by a third-party delivery service (e.g., a courier service, a transportation service, etc.). In some embodiments, the user's request for the ingredients may be sent to both a provider associated with supplying the ingredients and a provider associated with a transportation service, such as a ride-sharing service, such that the provider associated with supplying the ingredients may fulfill the order and the provider associated with the transportation service may deliver the fulfilled order. In some embodiments, an order may be fulfilled and/or delivered by the food management system. The purchase module 212 may notify the user once the order is fulfilled and/or delivered (e.g., via text, phone call, a notification in an application, etc.). In some embodiments, a user may set rules relating to when various ingredients are to be delivered. For example, a user may specify that salmon is to be delivered a particular number of days before the salmon is to be prepared for a particular meal, or that grocery items are to be ordered periodically (e.g., every 3 days). In some embodiments, the food management system may process the order transaction on behalf of a third party, and the food management system may subsequently process the transaction with the third party. In some embodiments, the food management system may fulfill the grocery order (e.g., supply ingredients, deliver ingredients, etc.).

In some embodiments the purchase module 212 may optimize a user's order request based on any suitable factors, such as pricing of various ingredients offered by different providers, location of various providers, based on when the recipes are to be prepared according to the meal plan, timing of delivery, ratings of providers, user preferences, and the like. In some embodiments, the purchase module 212 may order ingredients from one or more providers for a given user and/or meal plan. In some embodiments, the purchase module 212 may order ingredients requested by one or more users such that the ingredients may be purchased and/or delivered in bulk for a better price. In some embodiments, the purchase module 212 may combine orders for users and give each user a discount on the order and/or delivery price.

The recipe preparation module 214 may be a hardware-implemented module that may manage, control, facilitate, and provide information associated with preparing recipes. The recipe preparation module 214 may provide information to users about how to prepare a particular recipe (e.g., written instructions, visual instructions, video, audio, hologram, wearable device, etc.). In some embodiments, the information provided may be created and/or performed by the author of the particular recipe to be prepared. In some embodiments, the recipe preparation module 214 may provide information that may encourage a user to continue with their specified meal plan. For example, if a user has not accessed their account for a particular amount of time, the recipe preparation module 214 may send information to the user encouraging the user to continue their meal plan. In some embodiments, the recipe preparation module 214 may send a user reminders relating to preparing a particular meal, such as a reminder to defrost meat to be used in a recipe of the meal. In some embodiments, the recipe preparation module 214 may send information associated with a particular meal and/or recipe at any suitable time (e.g., before, during, or after preparation of the meal). For example, if a user is to prepare a meal with salmon, the recipe preparation module 214 may inform the user that salmon is good source for omega-3 fatty acids that help reduce high blood pressure. In some embodiments, the information sent may be rated by the user. In some embodiments, the recipe preparation module 214 may send the user ideas about what the user can do with the leftovers (e.g., turn corned beef dinner into a corned beef hash for breakfast the next day).

The user socialization module 216 may be a hardware-implemented module that may manage, control, and facilitate social features associated with the food management system. The user socialization module 216 may allow a user to create a personalized profile page, connect with other users, view profile pages of other users, share meal plans, post comments (e.g., tips for cooking healthy), share pictures and/or videos, and the like. For example, when a recipe and/or a meal is prepared by a user, the user may post pictures of their recipe and/or meal to the user's profile page, and other users may leave comments and/or ratings associated with the picture. The user socialization module 2016 may allow a user to rate various recipes they have prepared, share experiences with other users, leave comments about various recipes, share recipes, access a list of favorite recipes of other users, access other users' meal plans, share user-generated content (e.g., recipes, videos, etc.), create group shopping lists associated with a group of users (e.g., group list for users living in the same neighborhood to allow for bulk shopping), connect and communicate with various users and/or entities (e.g., an entity associated with a particular diet and/or meal plan), create groups of users (e.g., group of users with access to a group discussion board), and the like. In some embodiments, the user socialization module 216 may provide social features that allow users to compete with one another based on any suitable criteria (e.g., best presentation of a dish).

In some embodiments, the user socialization module 216 may provide a data feed to users that may allow users to receive updated data from various data sources. The data feed may be presented to users in any suitable manner, such as a web feed (e.g., a news feed), and a rich site summary (RSS) feed, and the like. The data feed may provide any suitable data to users, such as notifications about various events, the activity of other users within and/or outside of a user's social network (e.g., pictures posted by other users, messages from other users, new user connection requests, etc.), and the like.

In some embodiments, the user socialization module may allow users to connect with other users within a particular vicinity (e.g., a user in the same physical neighborhood of a city) for various purposes. For example, users may communicate with other users nearby such that users may connect with one another physically to have meals together, share leftovers, buy and/or sell any meals prepared, and the like.

The content management module 218 may be a hardware-implemented module that may store, manage, and provide content available to users, such as recipes, meal plans, videos, audio recordings, images, virtual reality, and the like. In some embodiments, the content management module 218 may allow users to create and manage user-generated content. For example, the content management module 218 may allow a user to create a recipe and/or a meal plan that may include pictures of a prepared recipe, an ingredients list for a recipe, instructions for preparing a recipe, videos, and the like. In some embodiments, the content management module 218 may provide a recipe template that may allow a user to create a recipe by populating the recipe template with various information associated with a recipe, such as pictures of the prepare recipe, ingredients for making the recipe, kitchen tools used to make the recipe, instructions for preparing the recipe, a video providing instructions about preparing the recipe, and the like. In some embodiments, the content management module 218 may provide a meal plan template that may allow a user to create a meal plan. For example, the content management module 218 may provide a meal plan template that may allow a user to drag and drop various recipes into a calendar view associated with a meal plan.

In some embodiments, the content management module 218 may provide video editing capabilities that a user may use to edit a video of the user giving a demonstration of preparing a particular recipe. In some embodiments, the content management module 218 may allow a user to create and provide a video having any suitable content. For example, a user may create and provide an instructional video about cooking

In some embodiments, the content management module 218 may provide suggestions to users creating content (e.g., a recipe, a meal plan, a video, etc.). The suggestions may be any suitable suggestions for any suitable purpose, such as a suggestion for formatting content, a suggestion about the type of content to include, and the like.

The marketing management module 220 may be a hardware-implemented module that may manage and control any marketing aspects associated with the food management system, including marketing associated with users, providers, and/or the food management system itself. For example, the marketing management module 220 may promote various grocery item brands, users (e.g., content creators), providers (e.g., grocery stores, restaurants, delivery service providers, etc.) using any marketing techniques (e.g., direct sales techniques, branded marketing, targeted marketing, etc.). In some embodiments, the marketing management module 220 may promote various entities associated with the food management system based on payment from those entities, based on a status of those entities (e.g., promoting highly-rated content creators, promoting entities that are new to the food management system, etc.), and the like.

The provider information module 222 may be a hardware-implemented module that may manage, control, access, and store information associated with providers (e.g., suppliers, transportation service providers, etc.). For example, the provider information module 222 may manage information associated with grocery stores, such as locations of various grocery stores, inventory available at various grocery stores, prices for various items in each grocery store, sales and/or promotions at various grocery stores, and the like. In other examples, the provider information module 222 may manage information associated with transportation service providers, such as the locations of various transportation service providers, prices, availability, ratings, and the like. The information may be visible to users and/or providers in any suitable manner. For example, a user may view a geographical map showing various grocery stores, and the user may click on a grocery store displayed on the map to view additional data about that particular grocery store (e.g., inventory, prices for various items, sales, etc.). The information managed by provider information module 222 may be accessed in any suitable manner. For example, a user may provide the information to the provider information module 222 via a computing device of the user as the user learns the information (e.g., crowd-sourced information for users in grocery stores), the providers may provide the information to the provider information module 222, and the like. In some embodiments, provider information module 222 may notify users about items that may be out of stock in certain locations. In some embodiments, provider information module 222 may access a grocery list of a user and display grocery stores based on the grocery list. For example, the provider information module 222 may display grocery stores that carry all or most of the items on a user's grocery list. In some embodiments, the provider information module 222 may display the cost of purchasing a set of ingredients at various grocery stores such that a user may compare prices.

The user communication module 224 may be a hardware-implemented module that may manage and control user communication in any suitable form. For example, the user communication module 224 may provide chat and/or messaging functionality such that users and/or providers may communicate with one another. In some embodiments, the user communication module 224 may allow users to make requests for various recipes and/or meal plans in any suitable manner. For example, the user communication module 224 may provide a forum and/or a digital bulletin board that may allow a user to request a particular meal plan that the user wishes to have fulfilled based on user-specified criteria, and users who create content may sort through, view, and fulfill these requests accordingly. For example, User A may request a meal plan that is suitable for a busy couple between the ages of 31-35 who live in San Francisco, wish to eat meals that are no more than 500 calories, and wish to pay no more than $10 per month for the meal plan. Various users may view this request, and any particular user (e.g., User B) may fulfill the request by creating a meal plan designed based on the criteria specified by User A. In some embodiments, users may be notified when their requests have been fulfilled by another user.

The health diary module 226 may be a hardware-implemented module that may provide functionality associated with an online health diary for a user of the food management system. The health diary module 226 may allow a user to access and maintain a health diary such that the user may log and/or monitor various aspects of the user's health, such as the user's food intake, calories, fat, carbohydrates, nutrients, exercise, activity level, weight, sleep, and the like. In some embodiments, the health diary module 226 may automatically update a user's health diary based on meal plans associated with the user. In some embodiments, the health diary module 226 may synchronize and access information associated with a wearable device of a user in order to log any health measurements tracked by the wearable device (e.g., heart rate, steps taken, stairs climbed, distance traveled, calories burned etc.).

The customer relationship management module 228 may be a hardware-implemented module that may manage, control, access, and provide information and/or features associated with managing clients who are associated with the food management system. The customer relationship management module 228 may provide an interface between various users who may be associated based on a client relationship. For example, health entities such as health coaches, meal planners, nutritionists, medical specialists, personal trainers, life coaches, and the like may have clients that may be managed using features provided by the customer relationship management module 228. For example, the customer relationship management module 228 may provide features that allow health entities to market themselves and/or be searched and found in any suitable manner (e.g., through client ratings, promotional materials, etc.). The customer relationship management module 228 may provide features that allow health entities to monitor their clients' health, such as monitoring food intake, fitness level and/or activities, clients' health diary, weight, and the like. In some embodiments, the customer relationship management module 228 may provide a health dashboard associated with a client that a health entity may view for each of the entity's clients, where the health dashboard may display various figures, graphs, tables, statistics, events, and/or activities related to the corresponding client's health. The customer relationship management module 228 may provide various analytical tools to health entities to aid in client management. For example, the customer relationship management module 228 may provide a health entity with analytical marketing tools that provide feedback about the health entity's marketing impact on potential and existing clients. The customer relationship management module 228 may provide analytical tools that may help a health entity succeed in and/or grow their business, such as analytics about how long the health entity is able to maintain each client. The customer relationship management module 228 may provide payment features to manage payment for services between a health entity and a client of the health entity.

The customer relationship management module 228 may be a scheduling tool that may automatically generate client communications for a health entity. For example, a health entity may specify preferences associated with sending communications to clients, and the customer relationship management module 228 may automatically generate communications based on those preferences (e.g., automatically send reminders to clients a day before a scheduled phone call, automatically send reminders to clients if they have not yet performed a certain specified action, etc.). These communications may be any suitable communication that may be sent in any suitable manner (e.g., email, text message, phone call, email, communication via the food management system, etc.). In some embodiments, the customer relationship management module 228 may have machine-learning capabilities that may be used for automatic communication generation. For example, the customer relationship management module 228 may learn that a health entity's client is more responsive to communications received in the morning and may adjust the timing of communications accordingly.

In some embodiments, the customer relationship management module 228 may manage information associated with a health entity's clients, such as client contact information, meetings scheduled with clients, client preferences and/or goals, and the like. In some embodiments, the customer relationship management module 228 may use a health entity's client information to intelligently provide reminders to the health entity about various client activity (e.g., remind health entity to communicate with a client after a particular amount of time has elapse since the last communication).

In some embodiments, the computing device 200 may allow a user to scan barcodes and/or take pictures of items to obtain any suitable information relating to the item, such as recipes, nutrition facts, prices, and the like. For example, a user may scan a barcode of a particular package to import the nutrition facts associated with the packaged food. In another example, a user may scan barcodes of ingredients the user may possess, and the information obtained from scanning the barcodes may be used to manage an inventory list associated with the user.

In some embodiments, the computing device 200 may gamify any features associated with the food management system. For example, recipes may be associated with a difficulty rating, and a user may receive an acknowledgement for completing a recipe for each difficulty level. In some embodiments, the computing device 200 may reward a user for achieving any suitable goal and/or task, such as user-specified goals, various diet goals, trying a particular dish and/or a particular number of dishes, being a well-traveled cook, inviting friends to join the food management system, and the like. In some embodiments, the computing device 200 may allow users to compete with each other in various ways (e.g., based on cooking meals, taking pictures of meals cooked, etc.). In some embodiments, the computing device 200 may allow users to earn badges, increase levels of difficulty in cooking, and the like.

In some embodiments, the computing device 200 may create and manage any suitable calendars and/or schedules associated with a group of users (e.g., calendars provided by the computing device 200, third-party calendars synchronized with the computing device 200, etc.). For example, an account may be associated with a household having any number of members, and the computing device 200 may manage calendars for each member. The calendar information may be used to help create meal plans based on which members will be eating which meals, when meals are to be eaten based on the household members' schedules, and the like. In some embodiments, the computing device 200 may manage any suitable items associated with a household, such as chores assigned to various household members, household finances, and the like. In some embodiments, a user with an account associated with the food management system may associate their account with another user's account such that various features and/or information may be shared between the users (e.g., a shared calendar, a shared meal plan, etc.). For example, this may allow users to remotely plan meals together. In some embodiments, users with synchronized accounts may each vote for particular meals to be prepared as part of a shared meal plan.

In some embodiments, the computing device 200 may provide an Application Program Interface (API) that may allow access to various features and/or data available on the food management system.

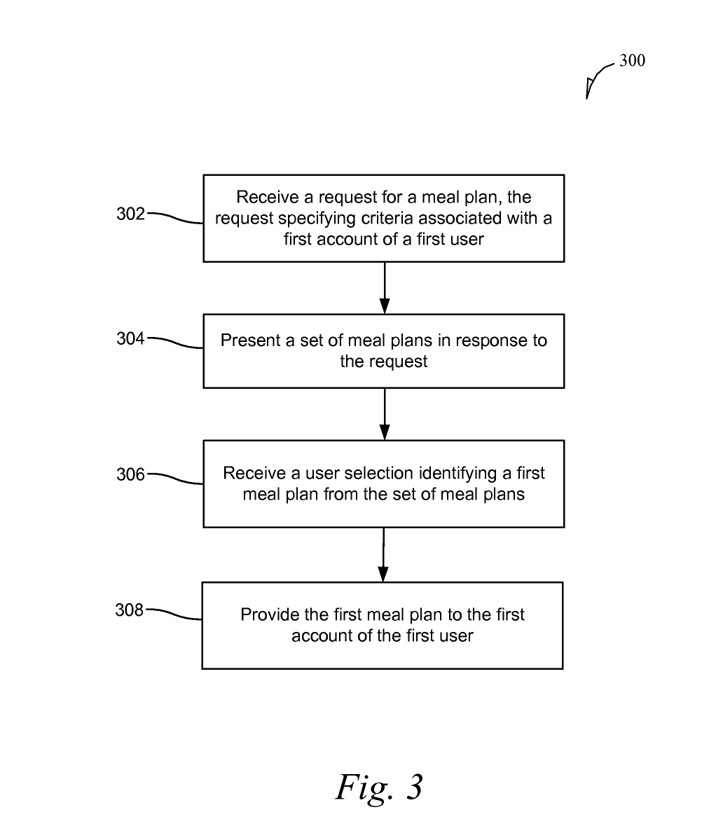

FIG. 3 is a flow chart showing an example method 300 for food management, in accordance with an example embodiment. The method 300 may be performed by the computing device 200 shown in FIG. 2 and provides an example of providing a meal plan to a user.

In operation 302, the meal plan management module 206 may receive a request for a meal plan, where the request specifies criteria associated with a first account of a first user. For example, a user that has an account with the food management system may submit a request specifying criteria associated with the type of meal plan the user would like to receive (e.g., a vegan meal plan with no broccoli).

In operation 304, the meal plan management module 206 may present a set of meal plans in response to the request. Each meal plan in the set of meal plans may be associated with a particular user and may fulfill at least a portion of the criteria specified. For example, the meal plan management module 206 may return various meal plans that fulfill at least some of the criteria specified in the user request. Each of the meal plans that are presented may be associated with a user account of a user who created the respective meal plan.

In operation 306, the meal plan management module 206 may receive a user selection identifying a first meal plan from the set of meal plans. The first meal plan may be associated with a second account of a second user and may specify one or more recipes. For example, the first user may select a particular meal plan that the user wishes to receive, and that meal plan may be associated with a second account of a user who created the selected meal plan.

In operation 308, the meal plan management module 206 may provide the first meal plan to the first account of the first user. The first meal plan may be provided to the account of the first user such that the first user may begin to use the meal plan selected.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

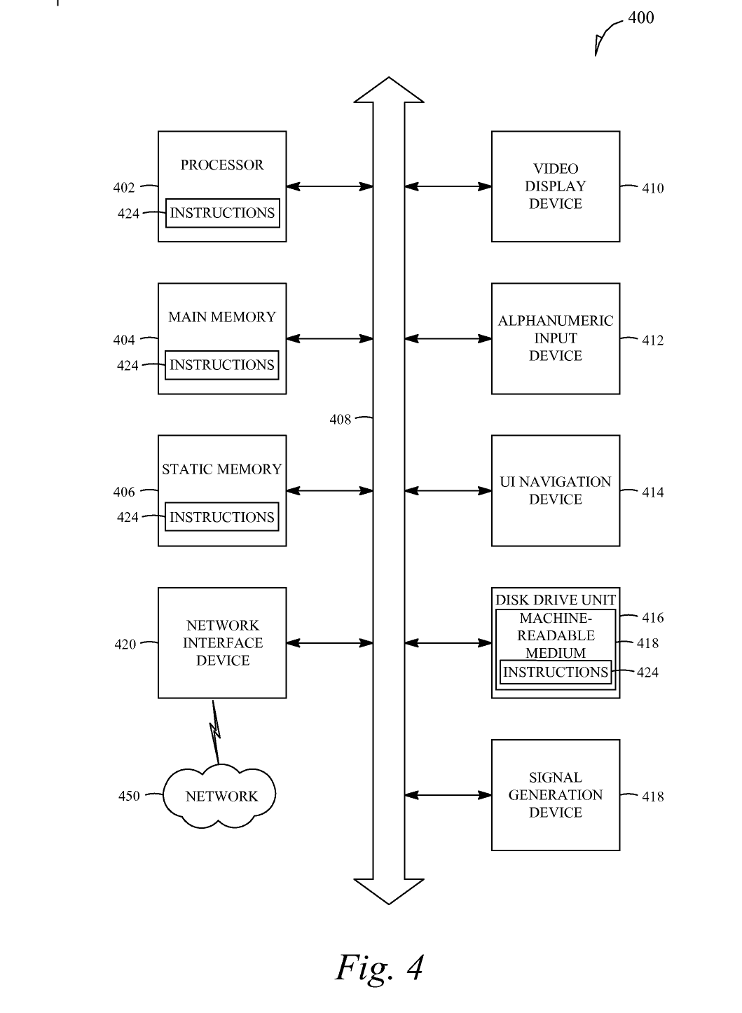

FIG. 4 is a block diagram of a machine in the example form of a computer system 400 within which instructions, for causing the machine to perform any one or more of the methodologies discussed herein, may be executed. In alternative embodiments, the machine operates as a standalone device or may be connected (e.g., networked) to other machines. For example, the machine may be connected to other machines via network 450, which may be any suitable network. In various embodiments, one or more portions of the network 450 may include an ad hoc network, an intranet, an extranet, a VPN, a LAN, a WLAN, a WAN, a WWAN, a MAN, a portion of the Internet, a portion of the PSTN, a cellular telephone network, or any other type of network, or a combination of two or more such networks. In a networked deployment, the machine may operate in the capacity of a server or a client machine in server-client network environment, or as a peer machine in a peer-to-peer (or distributed) network environment. The machine may be a PC, a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 400 includes a processor 402 (e.g., a central processing unit (CPU), a graphics processing unit (GPU) or both), a main memory 404, and a static memory 406, which communicate with each other via a bus 408. Computer system 400 may further include a video display device 410 (e.g., a liquid crystal display (LCD) or a cathode ray tube (CRT)). Computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

Disk drive unit 416 includes a machine-readable medium 422 on which is stored one or more sets of instructions and data structures (e.g., software) 424 embodying or utilized by any one or more of the methodologies or functions described herein. Instructions 424 may also reside, completely or at least partially, within main memory 404, within static memory 406, and/or within processor 402 during execution thereof by computer system 400, main memory 404 and processor 402 also constituting machine-readable media.

While machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 424 may further be transmitted or received over a communications network 426 using a transmission medium. Instructions 424 may be transmitted using network interface device 420 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

While the embodiment(s) is (are) described with reference to various implementations and exploitations, it will be understood that these embodiments are illustrative and that the scope of the embodiment(s) is not limited to them. Many variations, modifications, additions, and improvements are possible.

Plural instances may be provided for components, operations, or structures described herein as a single instance. Finally, boundaries between various components, operations, and structures are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method, comprising:
receiving, by a computing device, a request for a meal plan, the request specifying criteria associated with a first account of a first user;
presenting, by the computing device, a set of meal plans in response to the request, each meal plan in the set of meal plans being associated with a particular user and fulfilling at least a portion of the criteria;
receiving, by the computing device, a user selection identifying a first meal plan from the set of meal plans, the first meal plan being associated with a second account of a second user and specifying one or more recipes; and
providing, by the computing device, the first meal plan to the first account in response to the user selection.

2. The method of claim 1, further comprising:
determining, by the computing device, ingredients associated with the first meal plan;
identifying, by the computing device, a subset of the ingredients based on an inventory of ingredients; and
generating, by the computing device, a shopping list of items based on the subset of ingredients.

3. The method of claim 2, further comprising:
sending, by the computing device, an order request to a provider, the order request specifying the shopping list of items,
wherein the provider is an entity managing the computing device, a third-party food supplier, or a third-party transportation service.

4. The method of claim 1, further comprising:
providing, by the computing device, a recommendation to a user device of the first user, the recommendation relating to one or more of a particular recipe, a particular meal plan, a particular user, and a particular provider.

5. The method of claim 1, wherein providing the first meal plan to the first account comprises:
transferring, by the computing device, the first meal plan from the second account to the first account, wherein the first meal plan is created by the second user.

6. The method of claim 1, wherein the first meal plan is associated with a particular duration of time, each recipe of the one or more recipes specified in the first meal plan being assigned to a particular meal within the particular duration of time.

7. The method of claim 1, further comprising:
providing, by the computing device, a recipe template; and
receiving, by the computing device, a recipe of the one or more recipes specified in the first meal plan based on the recipe template, the recipe being received from a user device of the second user.

8. A computing device, comprising:
a hardware-implemented meal plan management module configured to:
receive a request for a meal plan, the request specifying criteria associated with a first account of a first user;
send display data to display a set of meal plans in response to the request, each meal plan in the set of meal plans being associated with a particular user and fulfilling at least a portion of the criteria;
receive a user selection identifying a first meal plan from the set of meal plans, the first meal plan being associated with a second account of a second user and specifying one or more recipes; and
associate the first meal plan with the first account in response to the user selection.

9. The computing device of claim 8, further comprising:
a hardware-implemented ingredients management module configured to determine ingredients associated with the first meal plan; and
a hardware-implemented grocery list creation module configured to identify a subset of the ingredients based on an inventory of ingredients and generate a shopping list of items based on the subset of ingredients.

10. The computing device of claim 9, further comprising:
a hardware-implemented purchase module configured to transmit an order request to a provider, the order request specifying the shopping list of items,
wherein the provider is an entity managing the computing device, a third-party food supplier, or a third-party transportation service.

11. The computing device of claim 8, wherein the hardware-implemented meal plan management module is further configured to provide a recommendation to a user device of the first user, wherein the recommendation relates to one or more of a particular recipe, a particular meal plan, a particular user, and a particular provider.

12. The computing device of claim 8, wherein the hardware-implemented meal plan management module is further configured to transfer the first meal plan from the second account to the first account, wherein the first meal plan is created by the second user.

13. The computing device of claim 8, wherein the first meal plan is associated with a particular duration of time, each recipe of the one or more recipes specified in the first meal plan being assigned to a particular meal within the particular duration of time.

14. The computing device of claim 8, further comprising:
a hardware-implemented content management module configured to provide a recipe template and receive a recipe of the one or more recipes specified in the first meal plan based on the recipe template, the recipe being received from a user device of the second user.

15. A non-transitory machine-readable storage medium storing instructions which, when executed by one or more processors, cause the one or more processors to perform operations, comprising:
receiving a request for a meal plan, the request specifying criteria associated with a first account of a first user;
presenting a set of meal plans in response to the request, each meal plan in the set of meal plans being associated with a particular user and fulfilling at least a portion of the criteria;
receiving a user selection identifying a first meal plan from the set of meal plans, the first meal plan being associated with a second account of a second user and specifying one or more recipes; and
providing the first meal plan to the first account in response to the user selection.

16. The non-transitory machine-readable storage medium of claim 15, wherein the instructions cause the one or more processors to perform further operations, comprising:
determining ingredients associated with the first meal plan;
identifying a subset of the ingredients based on an inventory of ingredients;
and generating a shopping list of items based on the subset of ingredients.

17. The non-transitory machine-readable storage medium of claim 16, wherein the instructions cause the one or more processors to perform further operations, comprising:
sending an order request to a provider, the order request specifying the shopping list of ingredients,
wherein the provider is an entity managing the computing device, a third-party food supplier, or a third-party transportation service.

18. The non-transitory machine-readable storage medium of claim 15, wherein the instructions cause the one or more processors to perform further operations, comprising:
providing a recommendation to a user device of the first user, the recommendation relating to one or more of a particular recipe, a particular meal plan, a particular user, and a particular provider.

19. The non-transitory machine-readable storage medium of claim 15, wherein providing the first meal plan to the first account comprises:
transferring the first meal plan from the second account to the first account, wherein the first meal plan is created by the second user.

20. The non-transitory machine-readable storage medium of claim 15, wherein the first meal plan is associated with a particular duration of time, each recipe of the one or more recipes specified in the first meal plan being assigned to a particular meal within the particular duration of time.
